(19) United States
(12) Patent Application Publication
(10) Pub. No.: US 2002/0087480 A1
(43) Pub. Date: Jul. 4, 2002

(54) Secure database for E-commerce

(76) Inventors: Nicholas Sauriol, Nepean (CA); Alex Sauriol, Kanata (CA)

Correspondence Address: James G. Gatto, Esq., Hunton & Williams, Suite 1200, 1900 K Street, N.W., Washington, DC, 20006, US

(21) Appl. No.: 09/749,408

(22) Filed: Dec. 28, 2000

(51) Int. Cl. G06F 17/60

(52) U.S. Cl. 705/67

(57) ABSTRACT

According to the present invention, a technique for providing a system and method that enables vendors and consumers to conduct E-commerce transaction while reducing the above described risks associated with each party. In some embodiments, the technique is realized by providing a secured network that stores consumer data in protected environment. In addition, some embodiments of the secured network may include an approved list of vendors that satisfy predetermined criteria.

### FIELD OF THE INVENTION

The present invention relates generally to electronic commerce (E-commerce), or commerce conducted over an interconnected processor based network and, more particularly, to a technique for providing a secured network which maintains consumer financial information in a secure fashion to enable users to make E-commerce transactions.

### BACKGROUND OF THE INVENTION

The growth of the Internet and other interconnected processor based networks has made it more convenient than ever to conduct E-commerce transactions. E-commerce may comprise the use of computers and electronic communications in business transactions. For example, E-commerce may include the use of electronic data interchange (EDI), electronic money exchange, Internet advertising, websites, online databases, computer networks, and point-of-sale (POS) computer systems.

One drawback of existing E-commerce systems is that when a consumer makes a purchase on-line (i.e., over the network, or on the Internet), most often it is over an unsecured line. As its name suggests, an unsecured line is susceptible to tampering, interception and other fraudulent activities.

Both vendors and consumers are vulnerable to fraud when transacting E-commerce over an unsecured line. For example, vendors may suffer penalties and other fees from credit providers (e.g., Visa™, MasterCard™, American Express™, etc.) for cancelled orders due to fraudulent charges. Likewise, consumers face credit history issues, liability for charges, and other unpleasant problems due to theft of their credit information.

Even the use of a secured line can have drawbacks. For example, many Internet sites are set up to prevent unauthorized people from seeing the information that is sent to or from those sites. These are called “secured” sites and may offer the customer some level of protection for their financial information. However, even with a secured line, vendors are still susceptible to fraud. For example, credit card numbers previously stolen from elsewhere may be used on a secure site. Likewise, computer programs exist that will generate fraudulent credit card numbers that will pass through some authorization checks (e.g., the card digits will satisfy a checksum authorization, etc.). Thus, the vendor is still exposed to fraudulent behavior even if the site is secured.

Another drawback of secured sites is that some secured sites require a higher level of connection security than what typically is installed on a consumer's computer. For example, in the United States or Canada, consumers may use 128-bit secured connection support, however, due to legal restrictions this software is not available worldwide.

In view of the foregoing, it would be desirable to provide a technique for conducting E-commerce which overcomes the above-described inadequacies and shortcomings. More particularly, it would be desirable to provide a technique for providing a database which maintains customer financial information in a secure fashion to enable customers and merchants (collectively, “users”) to make E-commerce transactions in an efficient and cost effective manner.

### SUMMARY OF THE INVENTION

According to the present invention, a technique for providing a system and method that enables vendors and consumers to conduct E-commerce transaction while reducing the above described risks associated with each party. In some embodiments, the technique is realized by providing a secured network that stores consumer data in protected environment. In addition, some embodiments of the secured network may include an approved list of vendors that satisfy predetermined criteria.

According to some embodiments of the invention the operation of the invention may be described with reference to the following example. In this example, a consumer initiates an E-commerce transaction by visiting a website of an approved vendor. The vendor's website which provides a button or other indicator to enable the consumer to initiate a secured network transaction. Once initiated the consumer may be prompted to enter a user identification code which is submitted along with other transaction information to the secured network. The secured network verifies that the consumer is registered with the secured network and that the vendor is an approved vendor. Once verified, the consumers financial information (e.g., credit card number, etc.) is securely transmitted to the vendor. In this manner, the consumer's information is protected from unauthorized access and the vendor is ensured that the consumer information is valid.

In accordance with other aspects of the present invention, there is provided an apparatus for enabling E-commerce transactions between a vendor and a consumer. In some embodiments, the apparatus comprises a secured network that stores consumer data and approved vendor information, includes a transaction receiver that receives transaction information at the secured network, a processor that processes the transaction information to determine whether the transaction information conforms with the stored consumer data and approved vendor information, and a delivery module that delivers the stored consumer data to the vendor if the transaction information is determined to conform with the stored consumer data and approved vendor information.

According to other aspects of the invention the secured network further comprises a virtual private network (VPN) that enables secured communication of the transaction information.

According to still other aspects of the invention the processor further comprises a consumer identification module that determines whether the transaction information contains a consumer identification indicator, and a vendor identification module that determines whether the transaction information contains a vendor identification indicator.

According to still other aspects of the invention the consumer identification module further comprises a first conformity module that determines whether the consumer identification indicator conforms with the stored consumer data, and the vendor identification module further comprises a second conformity module that determines whether the vendor identification indicator conforms with the stored approved vendor information.

The present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a schematic diagram of the overall system according to some embodiments of the invention.

FIG. 2 is a schematic flow diagram of a method for enabling an E-commerce transaction according to one embodiment of the invention.

FIG. 3 is a schematic diagram of components of a secured network according to one embodiment of the invention.

### DETAILED DESCRIPTION OF EXEMPLARY EMBODIMENT(S)

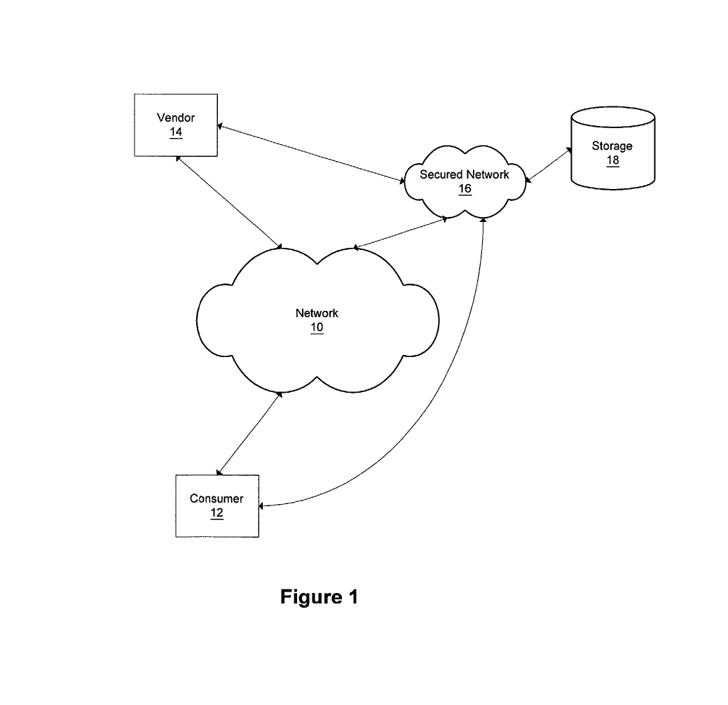

Referring to FIG. 1, there is shown a schematic representation of the overall system according to some embodiments of the invention. As shown, E-commerce transactions may occur over a network 10. Network 10 may comprise any suitable network for conducting E-commerce. For example, network 10 may comprise the Internet, a Wide Area Network (WAN), a Local Area Network (LAN), a wireless network, a private intranet, or other suitable network of interconnected processor based devices.

E-commerce transactions may take place over network 10 between various parties with access to network 10. For example, transactions may occur between consumer 12 and vendor 14. Of course, the labels “consumer” and “vendor” are used merely for ease of description herein. E-commerce transactions may take place between any type or number of parties interacting over network 10. For example, either consumer 12 or vendor 14 may comprise individuals, merchants, educational institutions, businesses, government agencies, corporations, non-profit organizations, or the like. In addition, FIG. 1 shows one example of an E-commerce transaction between one consumer 12 and one vendor 14, but the invention is applicable to transactions between a plurality of parties.

As indicated in FIG. 1, vendor 14 may have access to secured network 16. Secured network 16 may comprise any type of network capable of conducting secured transactions. For example, secured network may comprise a network connected to the Internet, a WAN, a LAN, or other suitable network.

Secured network 16 is indicated as a separate network in FIG. 1, however, in some embodiments secured network 16 may be a part of network 16. For example, secured network 16 may comprise an extranet (e.g., the part of an internal computer network which is available to outside users).

In some embodiments, secured network 16 may comprise a Virtual Private Network (VPN) or any other network which has the appearance and functionality of a dedicated line, but which is really like a private network within a public one, because it is still controlled by the service provider, and its backbone trunks are used by all customers.

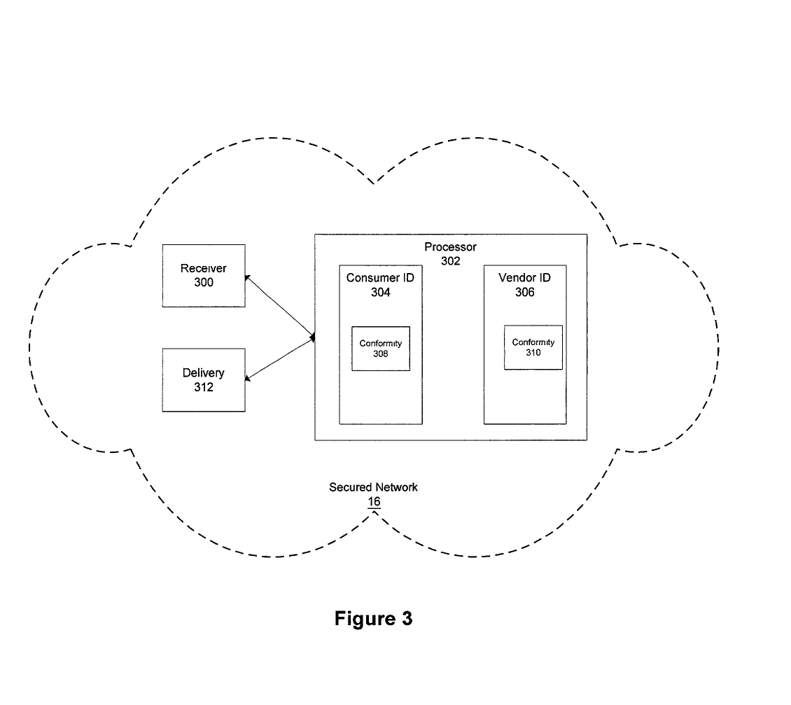

FIG. 3 is a schematic of some components of a secured network 16 according to some embodiments of the invention. As shown, secured network 16 may comprise a transaction receiver 300 that enables the receipt of an E-commerce transaction at secured network 16. Transaction receiver 300 may comprise any suitable software, hardware, or combination thereof, for receiving transaction information.

In some embodiments, secured network 16 may also comprise a processor 302. Processor 302 may, among other things, process the transaction information according to predetermined procedures. For example, in some embodiments, processor 302 may comprise a consumer identification module 304 and a vendor identification module 306. In some embodiments identification modules 304 and 306 may provide suitable software, hardware, or combinations thereof to identify the respective consumers 12 and vendors 14. For example, some embodiments of the identification modules 304 and 306 may respectively comprise a consumer identification conformity module 308 and a vendor identification conformity module 310 to determine whether the submitted identification information conforms to stored information for the respective parties.

In some embodiments, secured network 16 may also comprise a delivery module 312. Delivery module 312 may comprise any suitable software, hardware, or combination thereof that enables delivery of the stored consumer data to the vendor in order to facilitate the E-commerce transaction.

In some embodiments, secured network 16 may be administered by a host. The host is responsible for, among other things, screening and approving the vendors 14 that are granted access to secured network 16.

Approving vendors may comprise any suitable criteria for ensuring that the vendors are reputable and reliable. For example, vendors may have to qualify under predetermined “good business” criteria (e.g., preserve consumer confidentiality, exercise reasonable business practices, demonstrate ability to fill consumer orders, etc.). In some embodiments, vendors may have to carry insurance or post a bond with the host to qualify as approved vendors. Other methods of approving vendors are possible.

One purpose of approving vendors is to provide consumers with confidence that their E-commerce transactions will be conducted in a satisfactory and expected manner. Thus, approval procedures that achieve this and other similar goals may be used in some embodiments of the invention.

In some embodiments, secured network 16 may also collect and store consumer 12 data. Consumer 12 data may comprise any data that facilitates E-commerce transactions. For example, consumer 12 data may comprise credit card account numbers, other bank account numbers, consumer name, preferred delivery address, preferred billing address, preferred shipping method, or other information that facilitates an E-commerce transaction.

Consumer 12 data may be collected in any appropriate fashion. For example, in some embodiments, consumer 12 data may be collected by prompting a consumer 12 for input at a host website.

In some embodiments, a more secure mechanism for collecting consumer 12 data may be provided over a line that is isolated from network 10. For example, a separate secure dial-in line may be provided, a call in telephone line may be provided, or consumers may mail or fax data to the secure network 16. In this manner, the consumer 12 never transmits financial data over network 10. Other methods of collecting consumer 12 data are possible.

Embodiments of the invention may provide for storage of consumer 12 data. For example, secured network 16 may communicate with a storage device 18. Storage device may comprise a part of secured network 16, a stand alone device, a distributed storage device, or another type of database. For example, the database may include the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be incorporated in the invention.

In some embodiments, storage device 18 may provide appropriate security mechanisms to maintain consumer 12 information in a confidential manner. For example, a consumer 12 created user ID and password may be used to protect access to the stored consumer 12 information.

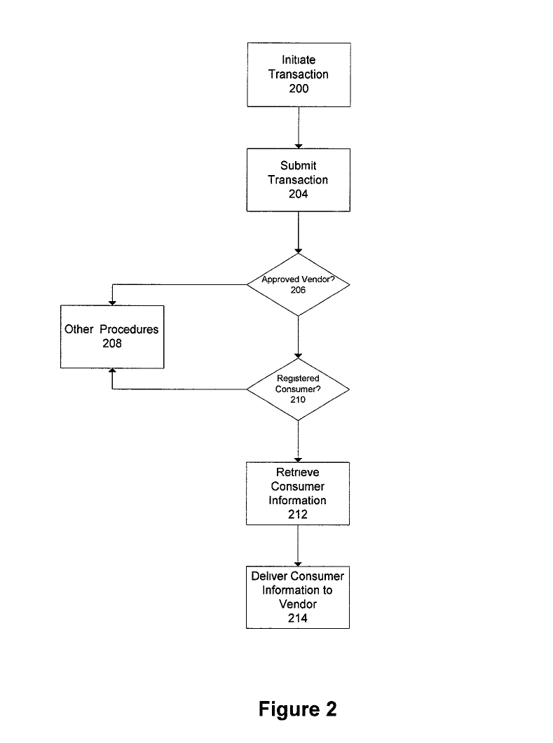

A method for enabling an E-commerce transaction according to one embodiment of the invention is described with reference to FIG. 2. As shown, the E-commerce transaction may initiate at step 200. Initiation step 200 may be accomplished in any suitable manner. For example, initiation step may occur when a consumer (e.g., consumer 12) visits an on-line shopping site on the Internet and causes a E-commerce transaction to begin (e.g., by clicking on or otherwise selecting a “purchase” or “buy” button located on the site).

Some embodiments provide an easily recognizable initiator (e.g., a button or link) to inform consumer 12 that the vendor 14 participates in the secured network 16. For example, the vendor 14 site may provide a logo, text, graphic, or other indication to consumers to select the initiator to start a secured network 16 E-commerce transaction.

In some embodiments the process proceeds to step 204 wherein the information contained in the E-commerce transaction may be submitted to the secured network 16 host. For example, the originating consumer 12 information (e.g., user ID), originating vendor 14, amount of purchase, type of delivery, or the like, may be submitted to the secured network 16 host.

Once submitted certain security measures may be implemented to ensure that the E-commerce transaction is genuine. For example, in some embodiments, an approved vendor check may occur at step 206 and a consumer registration check may occur at step 210. Approved vendor check 206 may comprise checking a vendor 14 identification number or the like to ensure that the vendor is one of the approved vendors. Similarly, consumer registration check 210 may comprise a verification that the consumer is a registered user of secured network 16 (e.g., that the consumer has submitted valid consumer data to the secured network 16). Other verifications (e.g., available credit balance, etc.) may also be performed in some embodiments.

In the event that the security measures (e.g., vendor check 206 or consumer registration 210) produce negative results (e.g., vendor not approved) then, in some embodiments, the process may proceed to other procedures at step 208. Other procedures may comprise any appropriate measures. For example, the transaction may be cancelled, one or both parties may receive notification, or other appropriate measures may be implemented at step 208.

In some embodiments, after appropriate security measures are completed with positive results the process may proceed to step 212 wherein consumer data may be retrieved. For example, consumer 12 credit card and shipping information may be retrieved.

In some embodiments, consumer data may be delivered to vendor 14 as indicated at step 214. As discussed above, some embodiments provide for secure delivery of the consumer 12 data to vendor 14 via secured network 16.

In this fashion, the invention provides a system and method for enabling an E-commerce transaction while reducing the risks to consumers and vendors.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A method for enabling E-commerce transactions between a vendor and a consumer, the method comprising the steps of:
providing a secured network that stores consumer data and approved vendor information;
receiving transaction information at the secured network;
processing the transaction information to determine whether the transaction information conforms with the stored consumer data and approved vendor information; and
delivering the stored consumer data to the vendor if the transaction information is determined to conform with the stored consumer data and approved vendor information.

2. The method of claim 1, wherein the step of providing a secured network further comprises:
providing a virtual private network (VPN) that enables secured communication of the transaction information.

3. The method of claim 1, wherein the step of processing the transaction information to determine whether the transaction information conforms with the stored consumer data and approved vendor information further comprises:
determining whether the transaction information contains a consumer identification indicator; and
determining whether the transaction information contains a vendor identification indicator.

4. The method of claim 3, further comprising:
determining whether the consumer identification indicator conforms with the stored consumer data; and
determining whether the vendor identification indicator conforms with the stored approved vendor information.

5. An apparatus for enabling E-commerce transactions between a vendor and a consumer, the apparatus comprising:
a secured network that stores consumer data and approved vendor information;
a transaction receiver that receives transaction information at the secured network;
a processor that processes the transaction information to determine whether the transaction information conforms with the stored consumer data and approved vendor information; and
a delivery module that delivers the stored consumer data to the vendor if the transaction information is determined to conform with the stored consumer data and approved vendor information.

6. The apparatus of claim 5, wherein the secured network further comprises:
a virtual private network (VPN) that enables secured communication of the transaction information.

7. The apparatus of claim 5, wherein the processor further comprises:
a consumer identification module that determines whether the transaction information contains a consumer identification indicator; and
a vendor identification module that determines whether the transaction information contains a vendor identification indicator.

8. The apparatus of claim 7, wherein the consumer identification module further comprises
a first conformity module that determines whether the consumer identification indicator conforms with the stored consumer data; and
wherein the vendor identification module further comprises
a second conformity module that determines whether the vendor identification indicator conforms with the stored approved vendor information.
